(19) United States
(12) Patent Application Publication
(10) Pub. No.: US 2016/0160469 A1
(43) Pub. Date: Jun. 9, 2016

(54) REDUCTANT TANK ENCLOSURE ASSEMBLY FOR MACHINES

(71) Applicant: Caterpillar Inc., Peoria, IL (US)

(72) Inventors: Saravanan Panneer, Trichy (IN); Sravana K. Kanchi, Plainfield, IL (US); Fernando Carrillo, Washington, IL (US)

(73) Assignee: Caterpillar Inc., Peoria, IL (US)

(21) Appl. No.: 15/046,456

(22) Filed: Feb. 18, 2016

(51) Int. Cl. E02F 9/08; B60K 15/067; F01N 3/24; B62D 25/08; B62D 25/10

(52) U.S. Cl. CPC E02F 9/0866; B62D 25/082; B62D 25/10; F01N 3/24; B60K 15/067; F01N 2610/1406

(57) ABSTRACT

A reductant tank enclosure assembly for a machine including a cab and a fender is provided. The enclosure assembly includes an enclosure, a cover assembly, a mounting assembly, and a reductant tank. The enclosure assembly is disposed on the fender and includes a wall with a longitudinal edge. The cover assembly is pivotably connected at the longitudinal edge. The cover assembly pivots to an open position to facilitate access to the enclosure The mounting assembly is attached with the fender and positioned inside the enclosure. The mounting assembly includes a support assembly, and a tray assembly pivotably coupled to support assembly. The support assembly includes a support plate attached to a mounting bracket. The reductant tank inside the enclosure is coupled to the tray assembly and pivots to an open position providing access to the reductant tank.

### TECHNICAL FIELD

The present disclosure relates to reductant tank modules for machines. More particularly, the present disclosure relates to a reductant tank enclosure assembly for a machine, which facilitates optimum positioning of a reductant tank.

### BACKGROUND

Internal combustion engines, including diesel engines, gasoline engines, gaseous fuel-powered engines, and other engines known in the art exhaust a complex mixture of air pollutants. These air pollutants are composed of gaseous compounds such as nitrogen oxides (NOx), and solid particulate matter also known as soot. Due to increased awareness of the environment, exhaust emission standards have become more stringent, and the amount of NOx and soot emitted to the atmosphere by an engine may be regulated depending on the type of engine, size of engine, and/or class of engine. In order to ensure compliance with the regulation of NOx, the engine may be provided with an aftertreatment system. The aftertreatment system is configured to treat and reduce NOx and/or soot present in an exhaust gas stream, prior to exit of the exhaust gas stream into the atmosphere. The aftertreatment system may include a selective catalytic reduction (SCR) module and a reductant delivery system, The SCR system involves injection of a gaseous or liquid reductant (most commonly urea) into the exhaust gas stream of the engine. The reductant used may be delivered by reductant delivery system associated with the SCR. The reductant delivery module may include a reductant tank for storage of a reductant, a reductant pump, reductant delivery lines and a reductant injector.

Typically, the reductant tank is positioned between the frame rails. This positions a tank fill neck proximal to critical components like hydraulic lines and fan lines. During reductant filling operation, the reductant tank may be overfilled. In such situations, spilling of the reductant may corrode the critical components over time. Further, the location of the reductant tank may be a remote location for an operator who is required to access the reductant tank for servicing. The service access for the reductant tank at the above mentioned location may be greatly restricted. This may result in increased service hours and machine down time to service and replace the reductant tank and/or the related components.

U.S. Pat. No. 8,695,827 discloses a system including a diesel exhaust fluid (DEF) tank and a fuel tank arranged in a portion of a vehicle to give that portion multiple structural functions. The system may be arranged to form a part of a counterweight on a work vehicle. The disclosed system may be unfavorable for machines with tiltable cab systems.

The present disclosure is directed towards one or more above-mentioned problems.

### SUMMARY OF THE INVENTION

Various aspects of the present disclosure describe a reductant tank enclosure assembly for a machine. The machine includes a cab and a fender. The fender includes a first lateral side which is proximal to the cab and a second lateral side which is distal to the cab. The reductant tank enclosure assembly includes an enclosure, a cover assembly, a mounting assembly, a support assembly, and a reductant tank. The enclosure is disposed on a portion of the fender proximal to the cab. The enclosure includes a wall having a longitudinal edge proximal to the second lateral side. The cover assembly is pivotably connected at the longitudinal edge. The cover assembly is structured to pivot to an open position to facilitate access to the enclosure. The mounting assembly is positioned inside the enclosure and is attached with the fender. The mounting assembly includes a support assembly, and a tray assembly. The support assembly includes a support plate attached to a mounting bracket. The support assembly is coupled to the fender. The tray assembly is pivotably coupled to the support assembly. Further, the reductant tank is coupled to the tray assembly of the mounting assembly. The reductant tank is disposed inside the enclosure, and pivots along with the tray assembly to an open position to facilitate access to the reductant tank.

### BRIEF DESCRIPTION OF THE DRAWINGS

FIG. 1 is a side view of an exemplary machine showing a fender and a cab, in accordance with the concepts of the present disclosure;

FIG. 2 is a perspective view of a reductant tank enclosure assembly of the machine of FIG. 1, including a mounting assembly in a closed position, in accordance with the concepts of the present disclosure;

FIG. 3 is a perspective view of the mounting assembly of FIG. 2 in an open position, in accordance with the concepts of the present disclosure;

FIG. 4 is the mounting assembly of FIG. 3 in engagement with the fender of the machine, in accordance with the concepts of the present disclosure; and

FIG. 5 is an exploded view of the mounting assembly of FIG. 4, in accordance with the concepts of the present disclosure.

### DETAILED DESCRIPTION

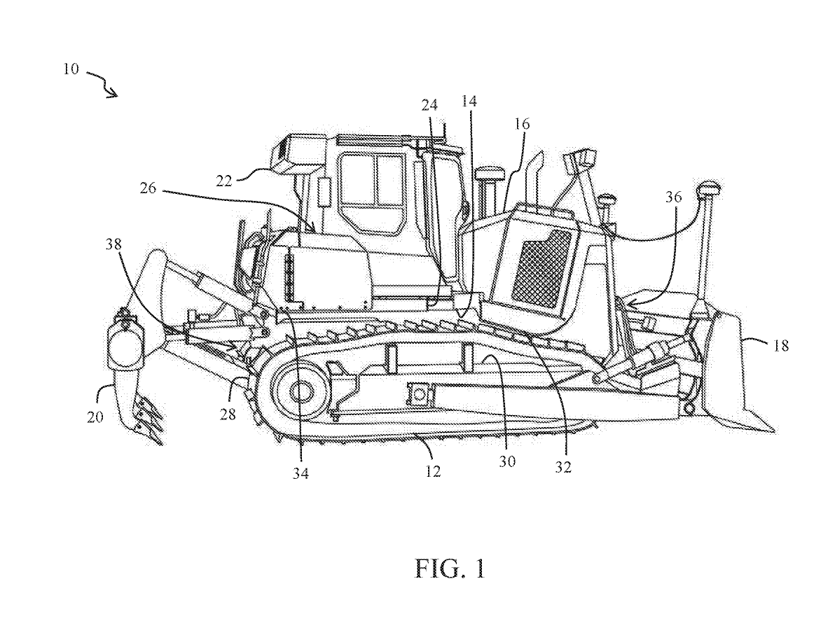

Referring to FIG. 1, there is shown a track type machine 10, which is commonly referred to as the machine 10. Examples of the machine 10 may include, but is not limited to, a track type excavator, a track type tractor, and a track type loader. The machine 10 includes two track arrangements 12 (one of which is shown in FIG. 1), a frame 14, an engine compartment 16, a blade 18, a ripper 20, an operator cabin 22, a fender 24, and a reductant tank enclosure assembly 26.

The track arrangements 12 are commonly known track assemblies that facilitate maneuvering of the machine 10 from one place to the other. Each of the track arrangements 12 includes a track 28 that moves around a telescopic track roller frame 30, to facilitate machine maneuvering. Moreover, the track arrangements 12 support the frame 14 of the machine 10.

The frame 14 is installed on the track arrangements 12 and is adapted to support various other components of the machine 10. More specifically, the frame 14 includes a first portion 32 and a second portion 34. The first portion 32 of the frame 14 is proximal to a frontal end 36 of the machine 10. The first portion 32 is adapted to support the engine compartment 16 and the blade 18 of the machine 10. More specifically, the blade 18 is attached to the first portion 32 and is adapted to clear the obstacles, during normal operation of the machine 10. The second portion 34 of the frame 14 is proximal to a rear end 38 of the machine 10. The second portion 34 is adapted to support the ripper 20, the operator cabin 22, and the fender 24 of the machine 10. More specifically, the ripper 20 is attached to the second portion 34 and is adapted to perform ripping operation on a ground surface, as the machine 10 traverses forward.

The operator cabin 22 is structured and arranged on the second portion 34 of the frame 14. The operator cabin 22 is capable of being tilted towards either of the two sides of the machine 10, to facilitate a varied degree of freedom for movement of the operator cabin 22. The operator cabin 22 houses a number of control systems that controls various functional items associated with the machine 10. Particularly, an operator may stand in the operator cabin 22 and may access the control systems, to manipulate one or more functional items associated with the machine 10.

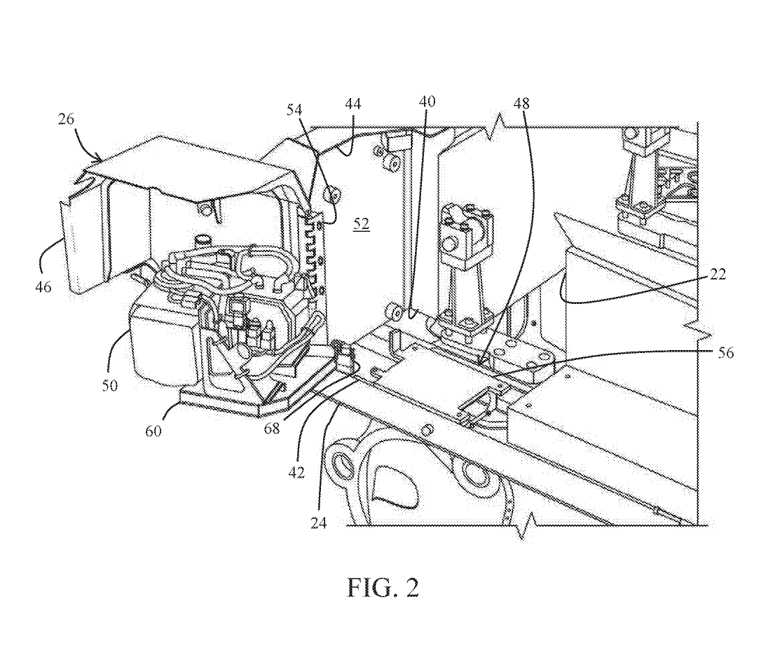

The fender 24 is installed on each side of the operator cabin 22 and is adapted to cover and protect each of the track arrangements 12 of the machine 10. More specifically, the fender 24 is installed proximal to the operator cabin 22. The fender 24 includes a first lateral side 40 (FIG. 2) and a second lateral side 42 (FIG. 2). The first lateral side 40 (FIG. 2) is in relative vicinity of the operator cabin 22 and the second lateral side 42 (FIG. 2) is distal relative to the operator cabin 22. Moreover, the fender 24 of the machine 10 is adapted to support the reductant tank enclosure assembly 26 of the machine 10.

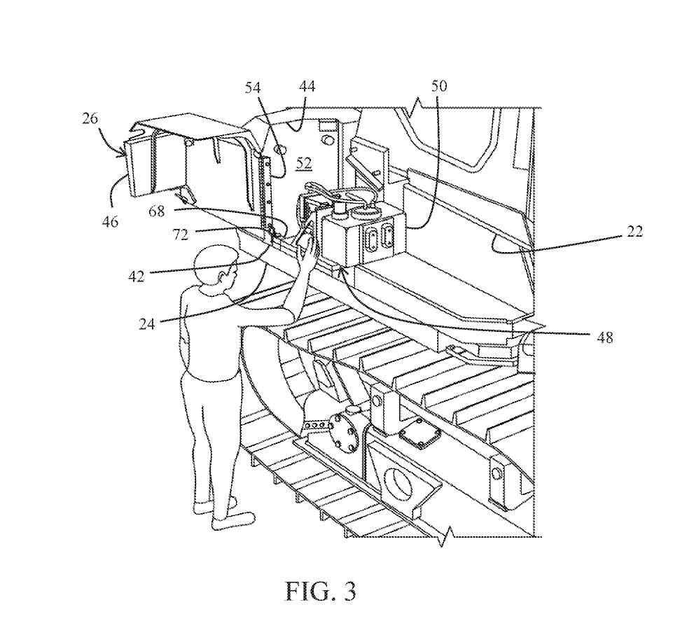

Referring to FIGS. 2 and 3, there is shown the reductant tank enclosure assembly 26 of the machine 10. The reductant tank enclosure assembly 26 is installed on the fender 24 of the machine 10, along one side of the machine 10. In the current embodiment, the reductant tank enclosure assembly 26 includes an enclosure 44, a cover assembly 46, a mounting assembly 48, and a reductant tank 50.

The enclosure 44 is installed on at least a portion of the fender 24, which is proximal to the operator cabin 22. More specifically, the enclosure 44 is fixedly installed proximal to the first lateral edge 40 of the fender 24. The enclosure 44 includes a wall 52 that extends towards the second lateral edge 42 of the fender 24. The wall 52 includes a longitudinal edge 54 proximal to the second lateral side 42 of the fender 24.

The cover assembly 46 is pivotably connected to the longitudinal edge 54 of the enclosure 44. The cover assembly 46 is structured and arranged to pivotably move between a closed position and an open position. In the closed position, the cover assembly 46 encloses the reductant tank 50 and restricts an access to the enclosure 44 and the reductant tank 50. In the closed position, the cover assembly 46 facilitates an access to the enclosure 44 and the reductant tank 50.

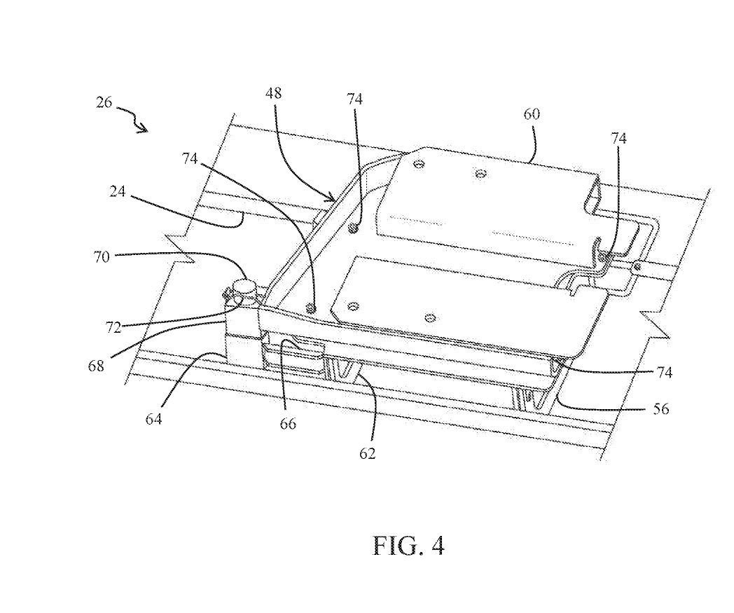

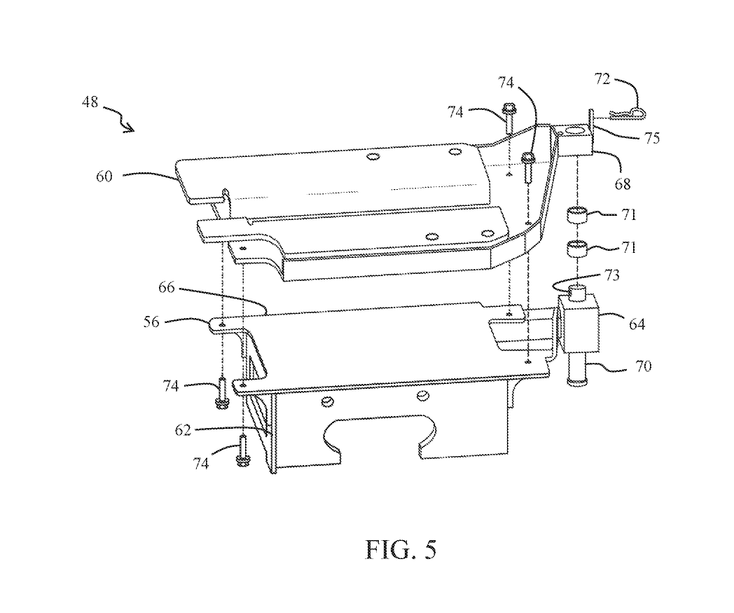

Referring to FIGS. 4 and 5, there is shown the mounting assembly 48 of the reductant tank enclosure assembly 26. The mounting assembly 48 is adapted to mount and support the reductant tank 50 of the reductant tank enclosure assembly 26. The mounting assembly 48 is attached to the fender 24 and is positioned inside the enclosure 44. The mounting assembly 48 includes a support assembly 56, and a tray assembly 60.

The support assembly 56 of the mounting assembly 48 is fixedly attached to the fender 24 of the machine 10. The support assembly 56 includes a mounting bracket 62, a pivot bracket 64, and a support plate 66. The mounting bracket 62 of the support assembly 56 is fixedly attached to the fender 24 of the machine 10. The pivot bracket 64 is fixedly attached to the mounting bracket 62 and is adapted to pivotably support the tray assembly 60. The support plate 66 is fixedly attached to the mounting bracket 62, with use of an attachment means, such as but not limited to, a weld and gusset attachment, a weld attachment, and/or a bolt attachment. Although, the present disclosure describes the mounting bracket 62, the pivot bracket 64, and the support plate 66 as individual components of the support assembly 56, it may be contemplated that the mounting bracket 62, the pivot bracket 64, and the support plate 66 may be portions of a singular integrated component of the support assembly 56.

The tray assembly 60 is pivotably coupled to the support assembly 56. The tray assembly 60 includes a pivot block 68. A pivot rod 70 passes through the pivot block 68 of the tray assembly 60 and the pivot bracket 64 of the support assembly 56, to facilitate a pivotal connection between the tray assembly 60 and the support assembly 56, More specifically, the pivot rod 70 is fixedly connected to the pivot bracket 64 and is rotatably positioned in the pivot block 68, via a number of bearing sleeves 71. This arrangement facilitates the pivotal connection between the tray assembly 60 and the support assembly 56. In an embodiment, a pin 72 passes through a hole 73 in the pivot rod 70 and a stopper bracket 75 on the pivot block 68, to restrict a vertical movement of the tray assembly 60 relative to the support assembly 56. Further, the pivotal movement of the tray assembly 60 is also restricted by attaching the support plate 66 with the tray assembly 60, with use of fasteners 74.

Referring again to FIGS. 2 and 3, the reductant tank 50 is attached to the tray assembly 60 of the mounting assembly 48 and is disposed inside the enclosure 44. The reductant tank 50 is configured to pivot, along with the tray assembly 60, between an open position and a closed position. As is shown in FIG. 3, in the closed position, the reductant tank 50, along with the tray assembly 60, is disposed within the enclosure 44. As is shown in FIG. 2, in the open position, the reductant tank 50, along with the tray assembly 60, are disposed outside the enclosure 44, to facilitate an access to the reductant tank 50.

### INDUSTRIAL APPLICABILITY

As is shown in FIG. 1, the reductant tank enclosure assembly 26 is installed on the fender 24 and houses the reductant tank 50. During normal operation of the machine 10, the reductant tank 50, along with the tray assembly 60, is in the closed position. Additionally, the cover assembly 46 is also in the closed position, during normal operation of the machine 10. This facilitates the reductant tank 50 to be positioned within the enclosure 44 and the cover assembly 46 covers the reductant tank 50.

As is shown in FIG. 3, during service and/or repair events of the reductant tank 50, an operator moves the cover assembly 46 from the closed position to the open position. In this position, the reductant tank 50 is positioned within the enclosure 44 of the reductant tank enclosure assembly 26. The operator then removes the fasteners 74 from the mounting assembly 48, to allow the pivotal movement of the tray assembly 60 relative to the support assembly 56. Thereafter, the operator pivotally moves the tray assembly 60, relative to the support assembly 56. This facilitates a movement of the reductant tank 50, along with the tray assembly 60 from the closed position to the open position.

As is shown in FIG. 2, in the open position, the reductant tank 50 is positioned outside the enclosure 44 and is accessible to the operator, for service and repair. As the reductant tank enclosure assembly 26 is installed on the fender 24, the reductant tank 50 is relatively easily accessible to the operator, for service and repair. Therefore, the serviceman may relatively easily fill the reductant tank 50 with reductant. This eliminates the chances of reductant spillage over critical components. Additionally, this reduces the service time and machine down time. Moreover, as the reductant tank 50 is capable of moving from the closed position to the open position, the reductant tank 50 accommodates for tilting of the operator cabin 22. More specifically, the reductant tank 50 is accessible even when the operator cabin 22 is tilted towards the reductant tank enclosure assembly 26.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A reductant tank enclosure assembly for a machine, the machine including a cab and a fender, the fender having a first lateral side proximal to the cab and a second lateral side distal to the cab, the reductant tank enclosure assembly including:
an enclosure disposed on a portion of the fender which is proximal to the cab, the enclosure includes a wall having a longitudinal edge proximal to the second lateral side;
a cover assembly pivotably connected at the longitudinal edge, the cover assembly structured to pivot to an open position to facilitate access to the enclosure;
a mounting assembly positioned inside the enclosure and attached with the fender, the mounting assembly including:
a support assembly including a support plate attached to a mounting bracket, the support assembly being coupled to the fender;
a tray assembly pivotably coupled to the support assembly; and
a reductant tank disposed inside the enclosure, wherein the reductant tank is coupled to the tray assembly of the mounting assembly, and configured to pivot along with the tray assembly to an open position to facilitate access to the reductant tank.
